(19) United States
(12) Patent Application Publication
(10) Pub. No.: US 2006/0153007 A1
(43) Pub. Date: Jul. 13, 2006

(54) Alarm clock with wireless earphones

(76) Inventor: Susan Chester, Columbus, NJ (US)

Correspondence Address: LITMAN LAW OFFICES, LTD, PO BOX 15035, CRYSTAL CITY STATION, ARLINGTON, VA, 22215, US

(21) Appl. No.: 11/030,047

(22) Filed: Jan. 7, 2005

(51) Int. Cl. G04B 47/00

(52) U.S. Cl. 368/12

(57) ABSTRACT

An alarm clock with wireless earphones has a housing and a power cord for interconnecting the housing with a power source which may be internal or external to the alarm clock. The alarm clock can include memory, one or more processors, a clock, one or more counters, a display, a tuner, one or more speakers, an alarm A, an alarm B, one or visual indicators, and one or more audio indicators. The alarm clock can also include a microphone, one or more transceivers, an antenna, one or more modems, one or more input/output interfaces, and one or more input/output ports. The alarm clock is configured to allow users set an associated alarm at a particular time and with a particular type of alarm, such as a voice message from family or friends. Users receive their selected alarm with a wireless earphone via a wireless communication link with the alarm clock.

### BACKGROUND OF THE INVENTION

1. Field of the Invention

The present invention generally relates to alarm clocks and, more particularly to an alarm clock with wireless earphones.

2. Description of Related Art

Alarm clocks are well known in the art and are typically used to wake up sleepers so they can begin their days. Many alarm clocks allow users to select amongst several different types alarms, such as chimes or an alarm bell, music from a radio station, music from a CD, etc. However, no alarm clocks currently provide users with the ability to hear wake up messages from family or friends. In addition, no alarm clocks currently allow separate users from receiving wake up messages privately, so as not to awaken or disturb the other users. As such, a need exists to provide users with an alarm clock with wireless earphones so the users can receive wake up messages from family and/or friends.

### SUMMARY OF THE INVENTION

The present invention is an alarm clock with wireless earphones. The alarm clock has a housing and a power cord for interconnecting the housing with a power source which may be internal or external to the alarm clock. The alarm clock can include memory with control logic or software embodied thereon, one or more processors, a clock, one or more counters, a display, a tuner, one or more speakers, an alarm A, an alarm B, one or visual indicators, one or more audio indicators. The alarm clock can also include a microphone, one or more transceivers, an antenna, one or more modems, one or more input/output interfaces, and one or more input output ports. Users receive their selected alarm with a wireless earphone via a wireless communication link with the alarm clock.

The alarm clock is configured to allow users set an associated alarm at a particular time and with a particular type of alarm. The times and/or alarms can be the same or different. The alarm types can be a voice message, or any other form of audio sound, such as music from a radio station, music from a CD, etc. The alarm clock is configured to enable users to select an alarm in the form of an audio sound including a voice message from any desired individual or group of individuals, such as family or friends. Users receive their selected alarm from the alarm clock via a wireless communication link.

The clock can be any type of conventional clock circuitry that can be set as desired through interaction by a user with input/output interfaces in the form of keys or buttons, such as hour, minute, etc. The clock can also be configured to be automatically set via receiving signals from an atomic clock to provide precise clock accuracy. The counter(s) are provided for activating desired alarms at predetermined times once the associated alarm and type of alarm has been set.

The display can be any type of display, such as a liquid crystal display (LCD), an organic LCD, a light emitting diode (LED) display, an organic LED display (OLED), a thin film transistor display, or the like. The display can also be a touch sensitive screen (“touch screen”) to enable users to select from options displayed on the touch screen's viewing surface by touching the surface adjacent the desired option or by touching the option directly. The display preferably displays time id digital form. However, the display can also be configured to display time in analog form.

The tuner is configured to receive radio communication signals via radio frequency waves. The tuner is preferably configured as an AM/FM tuner but can be configured to receive shortwave signals, television signals, etc. The speaker(s) can be any conventional speaker to emit sound from the alarm clock, such as alarm sounds, voice alarm messages, or other audio sounds. The alarm A can be set in a predetermined manner in the form of a recorded voice message from one or more family members or friends, a buzzer or chime, music or other sound from a particular radio station, music from a CD, etc.

Similarly, the alarm B can be set in a predetermined manner in the form of a recorded voice message from one or more family members or friends, a buzzer or chime, music or other sound from a particular radio station, music from a CD, etc. Through use of the microphone or other source, such as an interconnected computer, voice messages or other audio messages can be stored in the memory of the alarm clock. For example, a user can press or otherwise activate the microphone so the user can vocalize a desired message for alarm A or alarm B. Once the message is complete the message is saved for the designated alarm (A or B).

The transceiver(s) can be of a type well known in the art, and are preferably constructed of miniaturized solid state components so the transceiver(s) can be removably received in the alarm clock. The transceiver(s) can establish a two-way wireless communication link between the alarm clock and the wireless earphone(s) by way of the antenna.

The alarm clock can be provided with one or more modems to enable the alarm clock to receive desired audio sound in the form of recorded messages or any other type of audio sound from the internet or from a computer interconnected to the internet. The modem(s) can be any type well known in the art, such as a cellular capable modem, a softmodem, a chip modem, a wireless modem, etc.

The alarm clock includes one or more input/output interfaces which can be configured in the form of keys, buttons, or the like. The input/output interfaces can be translucent and can include visual indicators underneath to illuminate predetermined keys in the dark. The keys or button can be depressed, rocked, or activated for setting the time of the alarm clock, the alarm types and times for alarms A and B on the alarm clock, the volume, the channel, etc., as desired.

Each input/output interface key or button can have a typical alphanumeric or operational notation on its top or tactile surface. Each interface key or button can be coded by color, shape or other graphic symbol, and can also be coded by texture. The keys or buttons are preferably of the type requiring mechanical movement for activation. Audible feedback may also be provided, either through a mechanical feedback mechanism associated with the key structure or a separate electronic mechanism in the alarm clock. It is possible to include a touch sensitive surface to the alarm clock. A touch sensitive surface may be superimposed on the surface of the housing.

The alarm clock can be provided with an on/off key to turn the alarm clock on and off. A mode key can be provided to switch the alarm clock from one mode to another, such as from the clock to the AM/FM radio, etc. The volume keys adjust the volume of the alarm clock. The alarm keys set the type and time of the alarms, and switch the alarm settings on and off. The hour key sets an hour time. The minute key sets a minute time. The AM/FM key switches between AM and FM.

The input/output port(s) can include an audio port, a serial port, a parallel port, a universal serial bus port, a firewire port, an infrared port, a radio frequency port, or the like, to enable users to provide the alarm clock with voice messages or other audio alarm sounds from external sources.

The wireless earphone is preferably shaped for inserting in the ear canal of an individual so the earphone does not protrude in a visible manner. However, the earphone may be configured according to the desires of the user. The earphone includes a power source which may be a rechargeable and/or non-rechargeable battery. The earphone can include memory with control logic or software embodied thereon, one or more processors, one or more speakers, one or visual indicators, one or more audio indicators, one or more input/output interfaces, one or more transceivers, and an antenna. These components are substantially the same as described above for the alarm clock. However, the wireless earphone can be configured to enable a user to alter the received output once an alarm has been activated. For example, the alarm for a wireless earphone can activate and cause a voice message from family or friends to be transmitted from the alarm clock to the wireless earphone. Once the voice message is complete, the voice message can repeat over and over for a designated time interval, such as an hour or the like. Alternatively, the user can dial a knob or click a switch on the earphone to cause the output sound to change to music from a radio station or the like.

A computer arrangement can be configured for use with the alarm clock. Such an arrangement can includes a computer device, a monitor, a keyboard, and a mouse. The computer device is interconnected with memory storage unit via a cable or other linking device, and can be configured to be used with memory in the form of computer useable mediums, such as memory boards, removable memory elements (e.g., CD-ROMS, floppy disks, etc.), or the like. The computer device may be configured in the form of any type of computer as desired, such as a desktop computer, a laptop computer, a palmtop computer, a network computer, a personal digital assistant (PDA), a BlackBerry, a cell phone, an embedded device, a smart phone, or any other suitable computer device.

The computer device may wirelessly or non-wirelessly interconnect to the internet through the use of a browser via any known technique (e.g. wireless local area network (LAN), IrDA, Bluetooth, FireWire, etc.) or through a network system via any number of switches, such as LAN, a wide area network (WAN), an intranet, an extranet, the internet, etc., to enable a user to wirelessly or non-wirelessly access the internet through appropriate control signals.

A user can interconnect the alarm clock to the computer device to enable the user to transfer audio data in the form of recorded voice messages or the like from the computer device to the alarm clock. By depressing appropriate interfaces on the alarm clock, the user can provide desired audio data to the alarm A and/or alarm B. The audio data on the computer can be provided from other external devices, such as tape recorders, camcorders, the internet, etc.

### BRIEF DESCRIPTION OF THE DRAWINGS

FIG. 1 is a perspective view of a bedroom with people using an alarm clock with wireless earphones according to the present invention.

FIG. 2 is a perspective view of an alarm clock according to the present invention.

FIG. 3 is a block diagram of the alarm clock shown in FIG. 2.

FIG. 4 is perspective view of a wireless earphone according to the present invention.

FIG. 5 is a block diagram of the wireless earphone shown in FIG. 4.

FIG. 6 is a front perspective view of a computer device interconnected with an alarm clock according to the present invention.

Similar reference characters denote corresponding features consistently throughout the attached drawings.

### DETAILED DESCRIPTION OF THE PREFERRED EMBODIMENTS

The present invention is an alarm clock with wireless earphones. The invention disclosed herein is, of course, susceptible of embodiment in many different forms. Shown in the drawings and described herein below in detail are preferred embodiments of the invention. It is to be understood however, that the present disclosure is an exemplification of the principles of the invention and does not limit the invention to the illustrated embodiments.

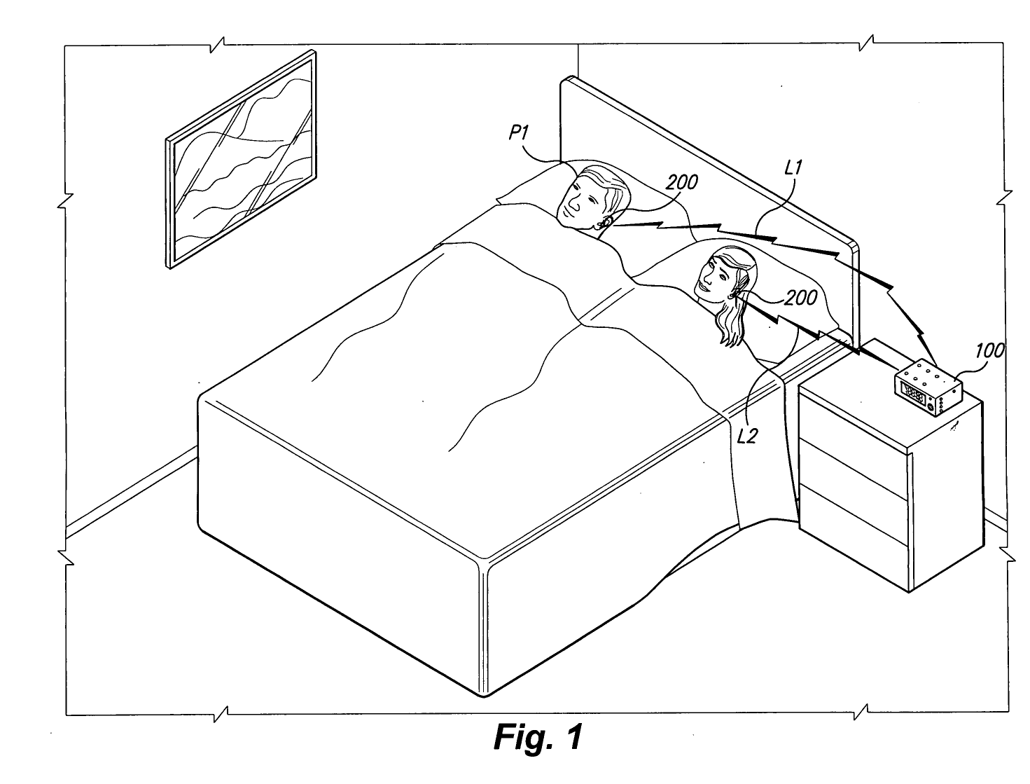

Referring to the drawings, FIG. 1 shows a bedroom with individuals P1 and P2 sleeping in a bed near a stand with an alarm clock 100 according to the present invention. Each person P1 and P2 are wearing wireless earphones 200 according to the present invention. The alarm clock 100 is configured to allow the people P1 and P2 to each set their associated alarm at a particular time and with a particular type of alarm. The times and/or alarms can be the same or different. The alarm types can be a voice message, or any other form of audio sound, such as music from a radio station, music from a CD, etc. The alarm clock 100 is configured to enable the people P1 and P2 to select an alarm in the form of an audio sound including a voice message from any desired individual or group of individuals, such as family or friends. Each person P1 and P2 receives their selected alarm from the alarm clock 100 via a communication link L1 or L2.

The alarm clock 100 can also be configured with any known features found on conventional alarm clocks. For example, the alarm clock 100 can be equipped to allow the people P1 and P2 to select an alarm in the form of a chime or bell, music from a radio station, music from a CD, or the like. The alarm settings for each person P1 and P2 can be set at different times so the users of the wireless earphones 200 inhibit disturbance from one individual to another.

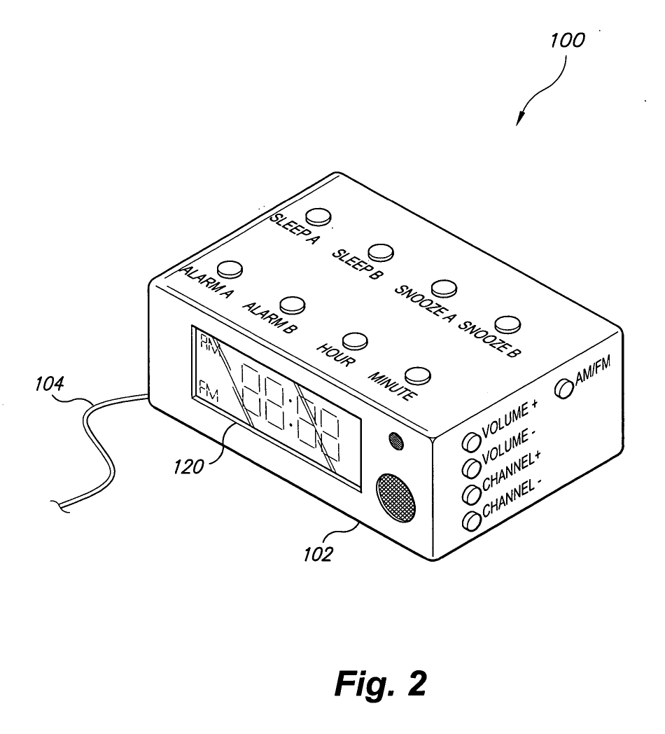

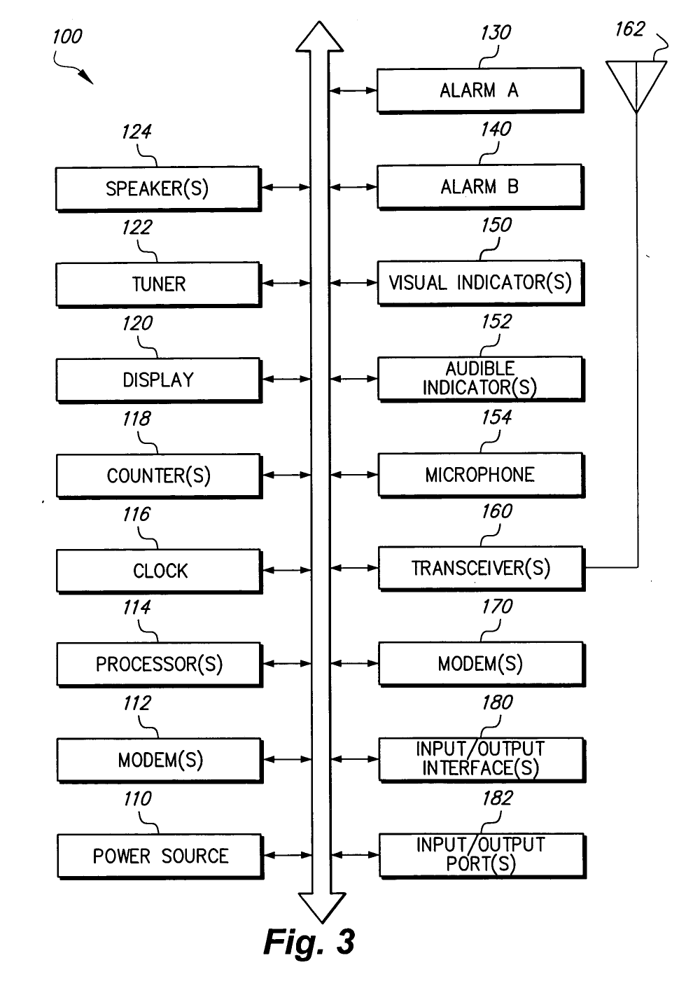

As shown in FIGS. 2 and 3, the alarm clock 100 has a housing 102 and a power cord 104 for interconnecting the housing 102 with a power source 110 which may be external to the alarm clock 100, such as utility power. The power source 100 may also be an internal power source, such as a battery or the like, and can augment any external power supply, in case of a power outage or the like. The alarm clock 100 can include memory 112 with control logic or software embodied thereon, one or more processors 114, a clock 116, one or more counters 118, a display 120, a tuner 122, one or more speakers 124, an alarm A 130, an alarm B 140, one or visual indicators 150, one or more audio indicators 152. The alarm clock 100 can also include a microphone 154, one or more transceivers 160, an antenna 162, one or more modems 170, one or more input/output interfaces 180, and one or more input output ports 182. These components are communicatively interconnected by a communication bus 190.

The alarm clock 100 is provided with memory 112 and one or more processors 114. The memory 112 can be interconnected with control logic or can have software embodied thereon. These components can be mounted on a circuit board within the housing 102 of the alarm clock 100. Such a circuit board can carry certain coupling and driver electronics with the processor 114 and the memory 112. The memory 112 can be configured as read only memory (ROM) and/or random access memory (RAM). In general, ROM is used to contain instructions and programs while RAM is employed for operating and working data. The memory 112 can also be configured in the form of a removable memory device, such as flash memory, memory stick, or any other type of removable memory device. The memory 112 can be removable or non-removable by the user.

The memory 112 can store software including an operating system and application programs to perform receive, read, and output functions of audio and/or voice message data that come into and are stored on the alarm clock 100. A software communications program can be provided to interface with a remote computer device that provides audio and/or voice message data via the modem 170.

The clock 116 can be any type of conventional clock circuitry that can be set as desired through interaction by a user with input/output interfaces 180 in the form of keys or buttons, such as hour, minute, etc. The clock 116 can also be configured to be automatically set via receiving signals from an atomic clock to provide precise clock accuracy. The counter(s) 118, are provided for activating desired alarms at predetermined times once the associated alarm and type of alarm has been set.

The display 120 can be any type of display, such as a liquid crystal display (LCD), an organic LCD, a light emitting diode (LED) display, an organic LED display (OLED), a thin film transistor display, or the like. The display 120 can also be a touch sensitive screen (“touch screen”) to enable users to select from options displayed on the touch screen's viewing surface by touching the surface adjacent the desired option or by touching the option directly. The display 120 preferably displays time in digital form. However, the display 120 can also be configured to display time in analog form.

The tuner 122 is configured to receive radio communication signals via radio frequency waves. The tuner 122 is preferably configured as an AM/FM tuner but can be configured to receive shortwave signals, television signals, etc. The speaker(s) 124, can be any conventional speaker to emit sound from the alarm clock 100, such as alarm sounds, voice alarm messages, or other audio sounds. The alarm A 130, can be set in a predetermined manner in the form of a recorded voice message from one or more family members or friends, a buzzer or chime, music or other sound from a particular radio station, music from a CD, etc.

Similarly, the alarm B 140 can be set in a predetermined manner in the form of a recorded voice message from one or more family members or friends, a buzzer or chime, music or other sound from a particular radio station, music from a CD, etc. Through use of the microphone 154 or other source, such as an interconnected computer, voice messages or other audio messages can be stored in the memory 112 of the alarm clock 100. For example, a user can press or otherwise activate the microphone 154 so the user can vocalize a desired message for alarm A or alarm B. Once the message is complete the message is saved for the designated alarm (A or B).

For example, a user may touch, hit, or otherwise engage an input/output interface 180 in the form of an alarm key or button for alarm A and/or alarm B to set the type of alarm and the time the alarm should become active. The keys or buttons may be configured for any desired sequence to select and set the alarm A and/or alarm B to a certain setting. A user could set alarm A and/or B for a voice message from their husband or wife saying something like “Honey, it's time to wake up!” or a cheerful message from one or more of their children saying “wake up mommy or daddy”. These messages can be changed as desired through use of the microphone 154 or through use of an interconnected computer.

The transceiver(s) 160 can be of a type well known in the art, and are preferably constructed of miniaturized solid state components so the transceiver(s) 160 can be removably received in the alarm clock 100. The transceiver(s) 160 can establish a two-way wireless communication link between the alarm clock 100 and the wireless earphone(s) 200 by way of the antenna 162.

The alarm clock 100 can be provided with one or more modems 170 to enable the alarm clock 100 to receive desired audio sound in the form of recorded messages or any other type of audio sound from the internet or from a computer interconnected to the internet. The modem(s) 170 can be any type well known in the art, such as a cellular capable modem, a softmodem, a chip modem, a wireless modem, etc.

The alarm clock 100 includes one or more input/output interfaces 180 which can be configured in the form of keys, buttons, or the like. For example, referring to FIG. 2, the alarm clock 100 may include an alarm A key, an alarm B key, an hour key, a minute key, a sleep A key, a sleep B key, a snooze A key, a snooze B key, an AM/FM key, a volume (+) key, a volume (−) key, a channel (+) key, a channel (−) key, etc. The input/output interfaces 180 in the form of keys or buttons can be translucent and can include visual indicators 150 underneath to illuminate predetermined keys in the dark. The keys or button can be depressed, rocked, or activated for setting the time of the alarm clock 100, the alarm types and times for alarms A and B on the alarm clock 100, the volume, the channel, etc., as desired.

Each input/output interface key or button 180 can have a typical alphanumeric or operational notation on its top or tactile surface. Each interface key or button 180 can be coded by color, shape or other graphic symbol, and can also be coded by texture. The keys or buttons 180 are preferably of the type requiring mechanical movement for activation. Mechanically actuated keys preferably have a depression stroke of at least one millimeter, and preferably two-to five millimeters. In addition, the keys preferably have tactile feedback, as known in the art. Audible feedback may also be provided through the audible indicator(s) 152, or through a mechanical feedback mechanism associated with the key structure or a separate electronic mechanism in the alarm clock 100. It is possible to include a touch sensitive surface to the alarm clock 100. A touch sensitive surface may be superimposed on the surface of the housing 102.

The alarm clock 100 can be provided with an on/off key to turn the alarm clock 100 on and off. A mode key can be provided to switch the alarm clock 100 from one mode to another, such as from the clock to the AM/FM radio, etc. The volume keys adjust the volume of the alarm clock 100. The alarm keys set the type and time of the alarms, and switch the alarm settings on and off. The hour key sets an hour time. The minute key sets a minute time. The AM/FM key switches between AM and FM.

The input/output port(s) 182 can include an audio port, a serial port, a parallel port, a universal serial bus port, a firewire port, an infrared port, a radio frequency port, or the like, to enable users to provide the alarm clock 100 with voice messages or other audio alarm sounds from external sources.

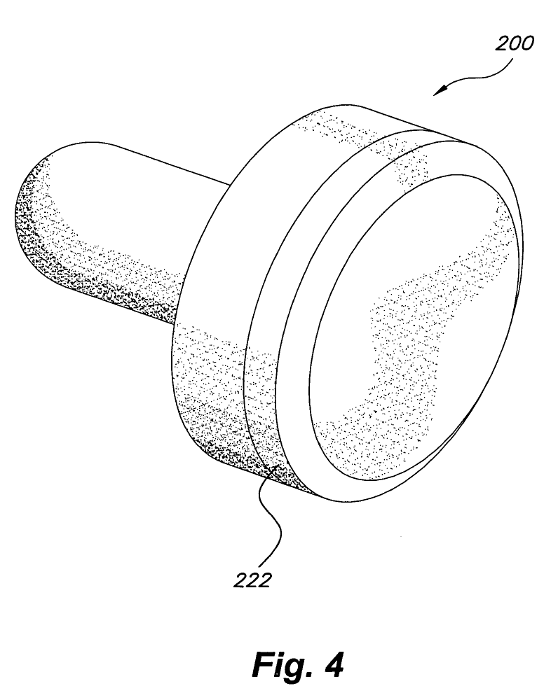

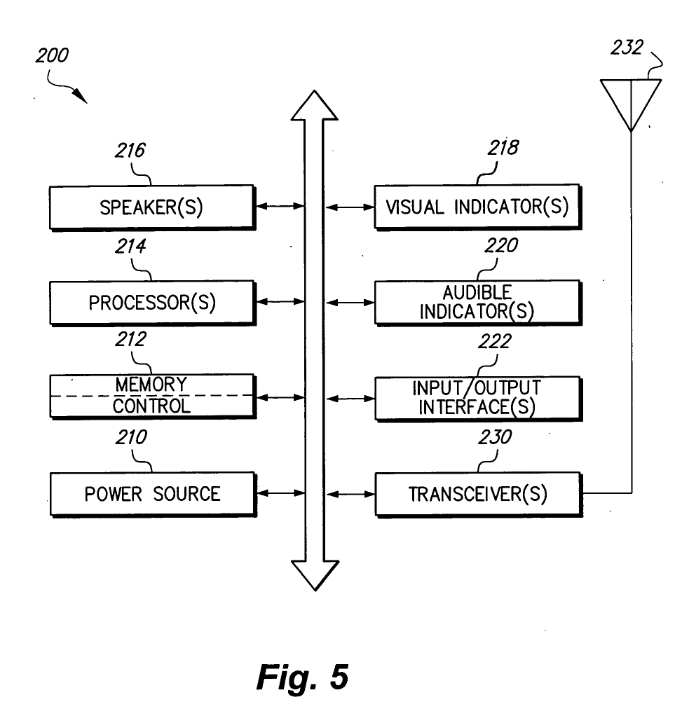

As shown in FIGS. 4 and 5, the wireless earphone 200 is preferably shaped for inserting in the ear canal of an individual so the earphone 200 does not protrude so as to be visible. However, the earphone 200 may be configured according to the desires of the user. The earphone 200 includes a power source 210 which may be a rechargeable and/or non-rechargeable battery. The earphone 200 can include memory 212 with control logic or software embodied thereon, one or more processors 214, one or more speakers 216, one or visual indicators 218, one or more audio indicators 220, one or more input/output interfaces 222, one or more transceivers 230, and an antenna 232. These components are substantially the same as described above for the alarm clock 100, and are communicatively interconnected by a communication bus.

However, the wireless earphone 200 can be configured to enable a user to alter the received output once an alarm has been activated. For example, the alarm for a wireless earphone 200 can activate and cause a voice message from family or friends to be transmitted from the alarm clock to the wireless earphone 200. Once the voice message is complete, the voice message can repeat over and over for a designated time interval, such as an hour or the like. Alternatively, the user can dial a knob or click a switch on the earphone 200 to cause the output sound to change to music from a radio station or the like.

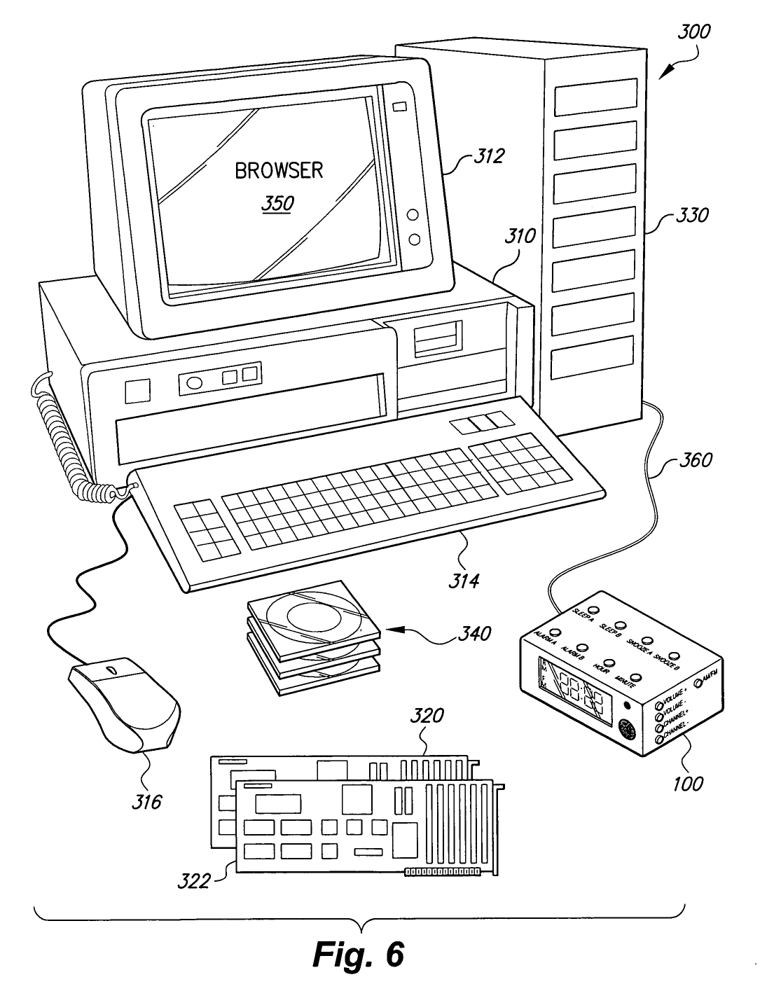

A computer arrangement 300, as shown in FIG. 6, can be configured for use with the alarm clock 100. The arrangement 300 can include a computer device 310, a monitor 312, a keyboard 314, and a mouse 316. The computer device 310 is interconnected with memory storage unit 330 via a cable or other linking device, and can be configured to be used with memory in the form of computer useable mediums, such as memory boards 320, 322, removable memory elements 340 (e.g., CD-ROMS, floppy disks, etc.), or the like. The computer device 310 may be configured in the form of any type of computer as desired, such as a desktop computer, a laptop computer, a palmtop computer, a network computer, a personal digital assistant (PDA), a BlackBerry, a cell phone, an embedded device, a smart phone, or any other suitable computer device.

The computer device 300 may wirelessly or non-wirelessly interconnect to the internet through the use of a browser 350 via any number of switches, such as LAN, a WAN, an intranet, an extranet, the internet, etc., to enable a user to wirelessly or non-wirelessly access the internet through appropriate control signals.

A user can interconnect the alarm clock 100 to the computer device 310 to enable the user to transfer audio data in the form of recorded voice messages or the like from the computer device 310 to the alarm clock 100. By depressing appropriate interfaces 180 on the alarm clock 100, the user can provide desired audio data to the alarm A and/or alarm B. The audio data on the computer can be provided from other external devices, such as tape recorders, camcorders, the internet, etc.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

I claim:

1. An alarm clock comprising:
a housing;
memory;
at least one processor;
a clock;
a display;
a tuner;
at least one speaker;
an alarm A;
an alarm B;
at least one transceiver configured to wirelessly transmit an audio alarm associated with alarm A or alarm B;
an antenna;
a communication bus interconnecting the memory, the at least one processor, the clock, the display, the tuner, the at least one speaker, the alarm A, the alarm B, and the at least one transceiver; and
at least one wireless earphone wirelessly interconnected with the alarm clock, the at least one wireless earphone being configured to wirelessly receive an audio signal associated with alarm A or alarm B, wherein the audio signal can include a prerecorded voice message from family or friends of a user of the alarm clock.

2. The alarm clock according to claim 1, further comprising a microphone configured to receive audio input for alarm A or alarm B.

3. The alarm clock according to claim 2, wherein said audio input is a voice message from family or friends of a user of the alarm clock.

4. The alarm clock according to claim 1, further comprising:
at least one counter;
at least one speaker;
at least one visual indicator; and
at least one audible indicator,
wherein the at least one counter, the at least one visual indicator, and the at least one audible indicator are interconnected to the communication bus.

5. The alarm clock according to claim 1, further comprising at least one modem interconnected to the communication bus.

6. The alarm clock according to claim 1, further comprising at least one input/output port interconnected to the communication bus.

7. The alarm clock according to claim 1, wherein said display is configured to display time in digital form.

8. The alarm clock according to claim 1, wherein said display is configured to display time in analog form.

9. The alarm clock according to claim 1, wherein said tuner is configured to receive radio communication signals via radio frequency waves.

10. The alarm clock according to claim 1, wherein said radio communication signals are AM/FM radio frequency waves.

11. The alarm clock according to claim 1, wherein said radio communication signals are shortwave signals.

12. The alarm clock according to claim 1, wherein said radio communication signals are television signals.

13. The alarm clock according to claim 1, wherein said display is a liquid crystal display (LCD), an organic LCD, a light emitting diode (LED) display, an organic LED display (OLED), or a thin film transistor display.

14. The alarm clock according to claim 1, wherein said at least one wireless earphone comprises:
a power source which may be a rechargeable and/or non-rechargeable battery;
memory;
at least one processor;
at least one speaker;
at least one transceiver;
an antenna, and
a communication bus interconnecting the power source, the memory, the at least one processor, and the at least one speaker, and the at least one transceiver.

15. The alarm clock according to claim 14, wherein said at least one wireless earphone includes two wireless earphones.

16. The alarm clock according to claim 14, wherein said at least one wireless earphone further comprises:
at least one visual indicator;
at least one audio indicator; and
at least one input/output interface,
wherein the at least one visual indicator, the at least one audio indicator, and the at least one input/output interface are interconnected to the communication bus.

17. The alarm clock according to claim 14, wherein said power source is a rechargeable battery.

18. The alarm clock according to claim 14, wherein said power source is a non-rechargeable battery.

19. The alarm clock according to claim 14, in combination with a computer arrangement configured to interconnect to the alarm clock and provide prerecorded audio data to the alarm clock.

20. The combination according to claim 19, wherein said computer arrangement comprises:
a computer device;
a monitor;
a keyboard; and
a mouse.
